(19) United States
(12) Patent Application Publication
(10) Pub. No.: US 2019/0378466 A1
(43) Pub. Date: Dec. 12, 2019

(54) DISPLAY AND THE DRIVING METHOD THEREOF

(71) Applicant: AU OPTRONICS CORPORATION, Hsin-Chu (TW)

(72) Inventors: Yu-Min Chi, Hsin-Chu (TW); Sung-Yu Su, Hsin-Chu (TW)

(21) Appl. No.: 16/263,180

(22) Filed: Jan. 31, 2019

(30) Foreign Application Priority Data
Jun. 12, 2018 (TW) 107120217

(51) Int. Cl. G09G 3/34

(52) U.S. Cl. CPC G09G 3/3413; G02F 1/133603

(57) ABSTRACT

A display device including backlight module, light valve groups such as display pixels disposed on the backlight module is provided, and the light valve group includes sub pixels. The backlight module includes light emitting arrays, and the light emitting array includes light emitting areas disposed along a first direction. The position of every light emitting arrays is corresponded to the position of one of the light valve groups, and the sub pixels of the light valve group are disposed along a second direction, and the first direction and the second direction are not parallel. When the light emitting areas of the light emitting array is emitting light, the illuminating light of every light emitting areas can illuminate multiple sub pixels. A driving method of the display device is also provided.

### FIELD OF THE INVENTION

The present invention is related to a display and the driving method thereof, especially to a display having a direct-lit backlight and the driving method thereof.

### BACKGROUND

In the existing display technique, light emitting diode (LED) related technique has became one of their main subject. The mainstreaming techniques in the market of LED include liquid crystal display (LCD) using light emitting diode as backlight and display with organic light emitting diode (OLED), and people continues to improve the display techniques in aspects such as the contrast and brightness of image, and the quality of colors and etc.

For example, when using the LED as backlight module of surface light source, the LCD technique will affect the appearance of black due to phenomena such as light leakage, even the whole contrast of the image will be affected. Moreover, to make the display image more delicate, there exists display using micro LED to provide lights for each one of the pixels. However, due to the nonlinear relationship between the current of the LED and the control voltage transmitted by the driving circuit of the LED, it is difficult to make adjustment by controlling the voltage signal. If the micro light source corresponded to each sub-pixel is increased, then the complexity of the overall circuit will increase with the quantity of micro LED. Therefore, when using micro LED as the light source for display pixel, the resolution of the display will be difficult to increase due to the aforementioned problems. Thus, how to create more advanced display techniques by LED becomes one of the main problems that needs to be solved.

### SUMMARY

The present invention is to provide a display which can provide more colors and brightness in every pixel so as to present a more colorful picture.

The display of the present invention includes backlight module and display pixels on the backlight module, and every display pixel includes sub-pixels.

The backlight module includes light-emitting arrays which includes light-emitting areas arranged along the first direction. The position of every light-emitting array corresponds to the position of one of the display pixels, and the sub-pixels of the display pixel are arranged along the second direction, which is not parallel to the first direction. When the light-emitting area of the light-emitting array emits light, every light-emitting area provides light to illuminate the sub-pixels.

The display of the present invention includes display components, and every display component includes light-emitting array and display pixel which includes sub-pixels disposed above the light-emitting array.

The light-emitting array includes multiple light-emitting areas arranged along the first direction, and the sub-pixels along the second direction which is not parallel to the first direction. When the light-emitting area in the light-emitting array emits light, every light-emitting area provides light to illuminate multiple sub-pixel.

The driving method of the display of the present invention includes providing gradient data which includes gradient values; acquiring the maximum gradient value in every gradient data; generating light-emitting control signal according to the maximum; providing light-emitting control signal to one of the light-emitting array in order to determine the lighting numbers of the light-emitting area in the light-emitting array; and providing gradient value to the sub-pixels corresponded to light-emitting array, then adjusting the transmittance of sub-pixels according to the gradient values in the gradient data received.

By making use of the display pixels, the display of the present invention has good performance in providing colors and brightness in detail, so as to offer a more delicate picture.

### BRIEF DESCRIPTION OF THE DRAWINGS

FIG. 1 is the schematic view of the display of the first example of the present invention;

FIG. 2A to FIG. 2C are the perspective exploded views of the display pixel of the first example of the present invention;

FIG. 3 is the top view of the display pixel of the first example of the present invention;

FIG. 4A is the flow chart of the driving method of the display of the first example of the present invention;

FIG. 4B is the system schematic view of the display of the first example of the present invention.

### DETAILED DESCRIPTION OF THE PREFERRED EMBODIMENT

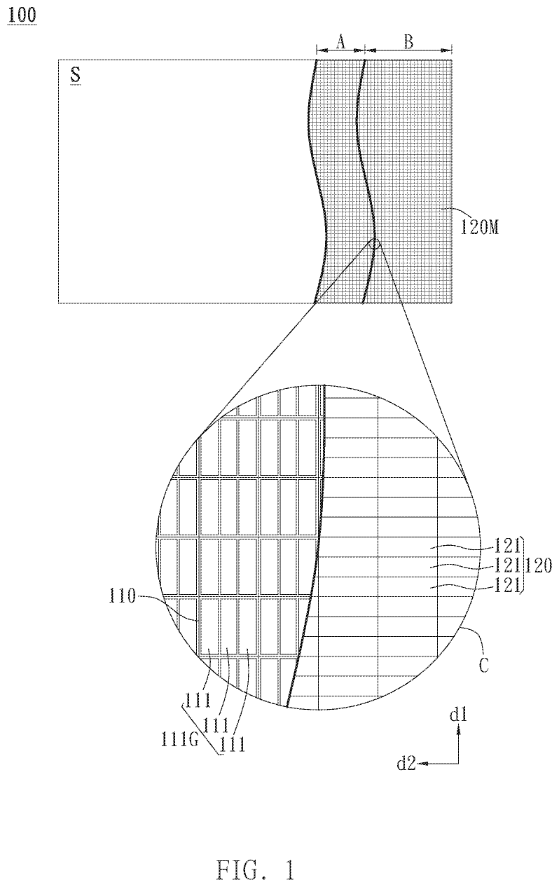

The display of the present invention can be applied to the displays for such as computer, television, advertising wall and etc., as well as portable devices such as tablet PC, smart phone and etc. FIG. 1 is the schematic view of display 100 of the first example of the present invention, wherein to be more explicit, the partial units are omitted in the partial area of the figure of the display 100, wherein the units above sub-pixel are omitted in area A, the units above light-emitting array are omitted in area B, and area C is the magnified view of partial area A and area B, the following will refer to these schematic views to further explain the relative position of each unit in display 100 of the example.

The display 100 of the first example of the present invention can, for example, provide image on the display surface S, and the image is composed by display pixels 111G. Every display pixel 111G includes sub-pixels 111, and the light-emitting array 120 lies beneath the sub-pixels. In other words, the distribution area of the display pixels 111G corresponds with the positions of the light-emitting arrays 120, which are the light source that being able to illuminates the sub-pixels 111 of the display pixels 111G.

For instance, the light-emitting arrays can together form a backlight module 120M, providing light for the sub-pixels 111 above, that is, the backlight module provides a direct-lit light source. However, the present invention is not limited to the arrangement of the light-emitting arrays 120, person having ordinary skill in the art can provide the light source with the same effect within display 100 by other arrangement.

Please refer to FIG. 1, the light-emitting array 120 of the first example of the present invention includes light-emitting areas 121, and, in every display pixel 111G, the arrangement of the light-emitting areas 121 are different from the sub-pixels 111. The light-emitting areas 121 are arranged along the first direction d1, whereas the sub-pixels 111 are arranged along the second direction d2. That is to say, the first direction d1 and the second direct d2 are different, they are not parallel to each other.

For instance, the sub-pixel 111 in the example is composed by such as light valve and color filter, wherein the preferred light valve is such as transmissive light valve of liquid crystal. The light-emitting area 121 is formed by such as the light-emitting surface of LED. Preferably, the light-emitting area of the example is composed by such as mini or micro LED (mini or pLED), LED, or OLED. The present invention is not limited to the device type of the light-emitting area 121 and sub-pixel 111, other devices with the same optical effect can even be used in other examples.

On the other hand, please refer to the partial magnified view in FIG. 1, the number of sub-pixels 111 in the display pixel 111G of the example is three for instance, that is, every three sub-pixels 111 in the display 100 form the display pixel 111G corresponded to light-emitting array 120, and the number of the light-emitting areas 121 of the light-emitting arrays 120 is also three for instance, and each of the sub-pixels 111 in display pixels 111G contain different chrominance which preferably correspond to the three optical primary colors. To take a step further, the display of the example includes display components 110, and every display component 110 includes display pixel 111G and light-emitting array 120. In every display component 110, the distribution area of the display pixels 111G and the distribution area of the light-emitting array 120 are overlapped, and the sub-pixels 111 in upper layer and the light emitting areas 121 in lower layer are arranged along different directions.

To be more explicit, the following will explain the detailed characteristics of the display of the example according to a single display pixel. Furthermore, the light-emitting array 120 of the example can present the brightness of the display component 110 by various lighting effects, that is, gray level (grayscale). The following will elaborate accordingly.

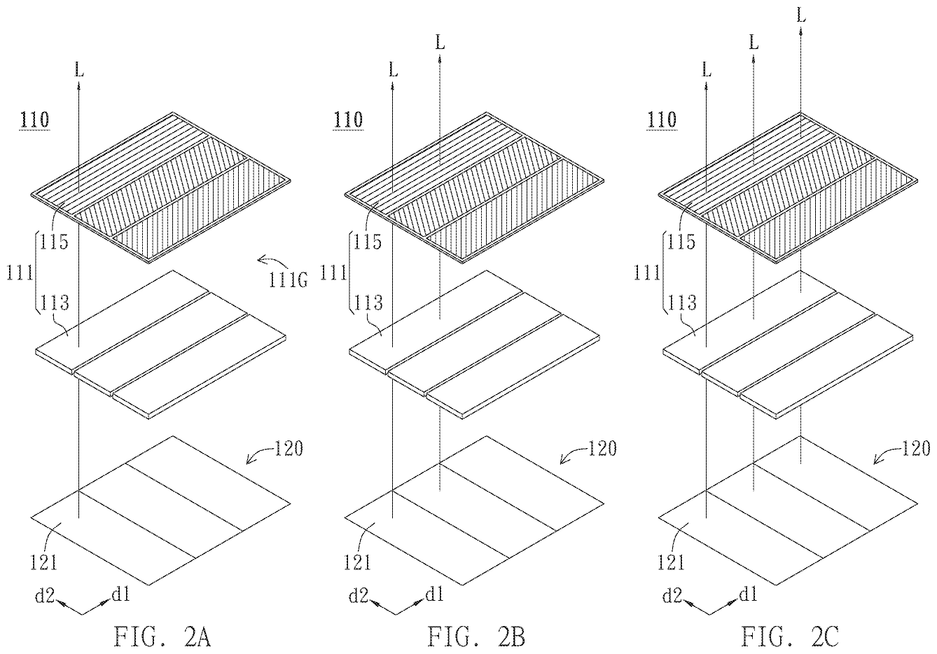

FIG. 2A-2C is the perspective exploded view of the display pixel and light-emitting array of the first example of the present invention. Please refer to FIG. 2A, the light-emitting areas 121 of the light-emitting array 120 provides light to illuminate the sub-pixels 111. Take the sub-pixels 111 in the referenced figure for instance, the sub-pixels 111 includes color filter 115 and light valve 113 such as liquid crystal, and the light L from light-emitting area 121 passes through these devices in order.

When the light-emitting array 120 lights up only one light-emitting area, only a part of every sub-pixel 111 will be illuminated by the light L, thus the display component 110 can present a gray level with lower brightness. In other words, the light-emitting array 120 that lights up a single light-emitting area 121 determines the gray level with lower brightness to be presented by the display component 110 in advance, then further controls the color and the transmittance of light L by sub-pixels 111 so as to further enhance the color and the gray level of the image with lower brightness presented by display component 110.

Please refer to FIG. 2B, when light-emitting array 120 lights up only two light-emitting areas 121, a greater area of the light valve 113 and color filter 115 of every sub-pixel 111 will be illuminated by the light L, thus the display component 110 can present gray level with higher brightness.

Please refer to FIG. 2C, when the light-emitting 120 lights all light-emitting areas 121, the greatest area of the light valve 113 and the color filter 115 of the sub-pixel 111 will be illuminated by the light L, thus display component 110 can present the gray level with highest brightness.

In other words, the light-emitting array 120 can preliminarily control the gray level of display component 110 by controlling the lighting quantities of the light-emitting area 121, then further controls the color and the transmittance of light by sub-pixel 111. Therefore, when providing no matter lower, medium or highest brightness, the light-emitting array 120 of every display component 110 of the display 100 can provide appropriate light source correspondingly. And by further controlling the transmittance with the sub-pixels 111, the display component 110 can greatly increase the number of gray levels and colors that the display 100 can provide.

In other words, by using the light-emitting arrays 120 of the present invention, the gray level of the picture can be controlled by not only the display pixel 111G such as liquid crystal, but also the lighting quantities of the light-emitting areas 121 of every light-emitting array 120 in the backlight module 120M, and further adjust the gray level of the image.

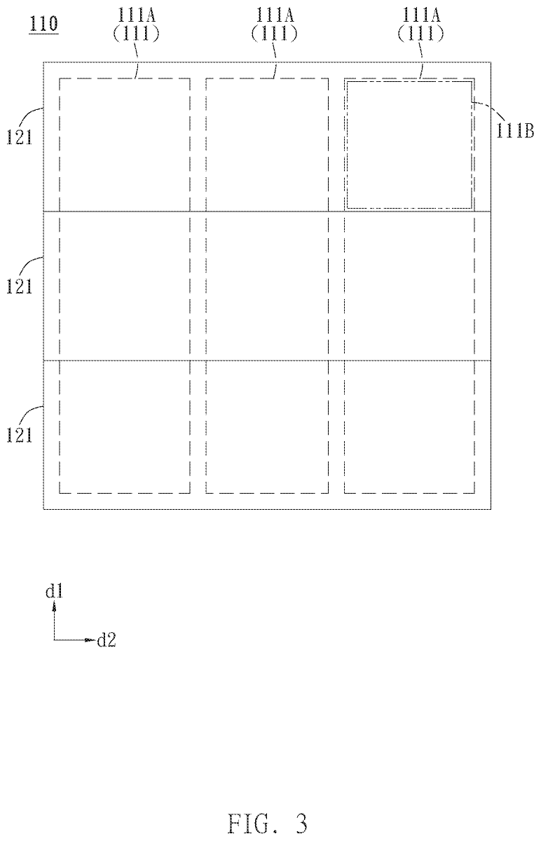

The following will illustrate the display of the example with another perspective. FIG. 3 is the top view of the display 100 of the first example of the present invention, wherein the units above the light-emitting array 120 are omitted in the figure. Please refer to FIG. 3, in the light-emitting array 120 of the example, the light-emitting area 121 is emitting light from a light-emitting surface. Moreover, FIG. 3 is the schematic view drawn according to the light-emitting surface, wherein the light-emitting area 121 is arranged along the first direction d1, and the light-emitting surfaces of the light-emitting areas 121 is substantially distributed on the light-emitting surface.

The display pixel is disposed above the light-emitting areas 121, and the areas 111A of the sub-pixels 111 in the display pixel projected on the light-emitting area are overlapped and interlaced with the distribution areas of the light-emitting areas 121. For instance, every projected area 111A of the sub-pixel on the light-emitting surface will overlap with all the distribution areas of three light-emitting areas 121, thus every sub-pixel 111 (refer to projected area 111A) can form such as three sub-areas 111B (one is marked in the figure), and the partial sub-pixels 111 corresponded to one of the sub-area 111B can receive the light emitting from one of the light-emitting areas 121, and the whole sub-pixels 111 can receive light from different light-emitting areas in different areas. Therefore, by determining the lighting numbers of light-emitting area 121, the overall brightness of the sub-pixels 111 is determined.

The light-emitting area 121 of the example is rectangular shaped with the long side being perpendicular to the first direction d1, whereas the sub-pixels 111 across above the light-emitting areas 121 is rectangular shape with the long side being perpendicular to the second direction d2, and thus form numerous rectangles or squares sub-areas 111B on the sub-pixel 111. Furthermore, the sub-areas 111B, for instance, possess the same dimension, thus good gradient brightness control can be provided in the display component 110.

However, the present invention is not limited to the shape of the light-emitting area 121 and sub-pixel 111. In other examples, the sub-pixel can even be formed in other shapes, also, the light-emitting area can even correspond accordingly and form in another shape to illuminate the sub-pixels at the same time. On the other hand, in the display component 110 of the first example of the present invention, the arranged direction d1 of the light-emitting areas 121 is perpendicular to the arranged direction d2 of the sub-pixels 111, so as to form preferably the sub-areas 111B with the same dimension in order to provide good gradient brightness control. But the present invention is not limited to this, in other examples, the arranged direction of the light-emitting area 121 and sub-pixel 111 can even form various angles, person having ordinary skill in the art can adjust the arranged direction according to the shape of the light-emitting area 121 and sub-pixel 111 or the needs of the display pixel.

Furthermore, the intensity of the lights emitting from the light-emitting areas 121 of the example are similar, thus the light-emitting areas 121 of the light-emitting array 120 are exchangeable. By controlling the lighting number of the light-emitting areas 121 of the light-emitting array 120, the brightness range of the display component 110 can be adjusted.

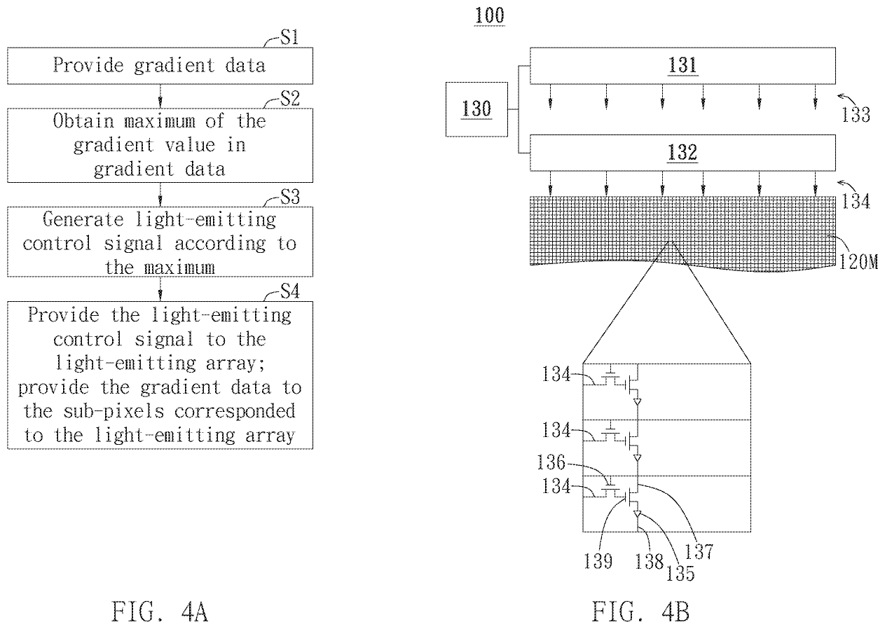

The following will further elaborate on the driving method of the display of the present invention. Please refer to FIG. 4A, showing the flow chart of the driving method. The display of the first example of the present invention first provides a gradient data (Step S1) which can control the display pixel. Gradient data includes numerous gradient values which is capable of controlling the transmittance of every sub-pixel of the display pixel respectively. The gradient value of the example, for instance, and the transmittance of the sub-pixel are positively correlated, but the present invention is not limited to this.

On the other hand, the maximum gradient value is obtained from the gradient data and a light-emitting control signal is generated according to the maximum gradient value (Step S2). For instance, when the light-emitting array of the display pixel has three light-emitting areas, the range of the gradient value will be divided into three value sections, each corresponds light-emitting control signal lighting one, two or three light-emitting area. Therefore, after obtaining the maximum gradient value in the gradient data, the corresponded light-emitting control signal is provided according to the section the maximum gradient value is in, so as to control the lighting numbers of the light-emitting area of the display pixel.

In other words, the display determines the light-emitting control signal according to the sub-pixel with the highest brightness requirement in the display pixel. For instance, to control the range of the gradient value of the transmittance of the sub-pixel between, for example, 0 to 255, and the light-emitting control signal can be determined according to such as the following rules:

when the maximum gradient value in the gradient data falls in the range between 0 to 155, the corresponded light-emitting control signal can light up one light-emitting area; when the maximum gradient value falls in the range between 156 to 212, the corresponded light-emitting control signal can light up two light-emitting areas; when the maximum gradient value falls in the range between 213 to 255, the corresponded light-emitting control signal can light up three light-emitting areas. In the aforementioned rules, every gradient value can correspond to a light-emitting control signal.

On the other hand, please further refer to FIG. 4B, the system schematic view, where the gradient value of the display 100 is transmitted from the timing controller 130 to the first data driving circuit 131 which transmits the gradient data to every sub-pixel of the display pixel via the first data line 133. Meanwhile, the light-emitting control signal generated according to the gradient data can also be transmitted from, for example timing controller 130 to the second data driving circuit 132 which transmit the light-emitting control signal to every light-emitting area 121 of the the display pixel via the second data line 134 (Step S4). In other words, when a gradient data is provided to a display component, the first data driving circuit 131 can pass the gradient data to the display pixel via the first data line 133; the second data driving circuit 132 can pass the light-emitting control signal to the light-emitting array of the display pixel via the second data line 134.

Please refer to the partial magnified view in FIG. 4B, the light-emitting area 121 of the example provides light by such as LED 135, and the switch 136 connected to the second data line 134 is connected to the switch 139 which is disposed between the power line 137 and 138 of the LED 135. Therefore, the gradient data can control the transmittance of the sub-pixel of a display pixel and the lighting numbers of the light-emitting area in the display pixel at the same time, so as to provide good picture.

Moreover, the display of the example can acquire the maximum gradient value and further calibrate with such as Gamma 2.2 curve to obtain a calibrated maximum. The light-emitting control signal is then generated according to the calibrated maximum so as to control the lighting numbers of the light-emitting area in the light-emitting array.

For instance, the relationship between the maximum and the calibrated maximum gradient value is as followed:

Y (calibrated maximum)=A×X^{2.2}

wherein A is a constant, X is the maximum gradient value. The maximum gradient value can convert the calibrated maximum according to the relationship, then determine the light-emitting control signal according to the calibrated maximum. Therefore, the display of the example can provide the most suitable image for human vision according to the driving method.

To sum up, the display of the present invention can control the brightness of the light in advance by the light-emitting array, then subdivide the transmittance via sub-pixel. In other words, making use of the lighting numbers of the light-emitting area in the light-emitting array and the transmittance control of the sub-pixel, the display can enhance the details of brightness and colors greatly. The driving method of the display of the present invention can determine directly the lighting numbers of the light-emitting area in the light-emitting array corresponded to every sub-pixel according to the gradient data provided to the sub-pixel, thus a more colorful and delicate picture can further be provided according to the gradient data applied to the existing display.

1. A display including:
a backlight module, including a plurality of light-emitting arrays, and every light-emitting array includes multiple light-emitting areas arranged along a first direction;
a plurality of display pixels, disposed on the backlight module;
wherein every display pixel includes a plurality of sub-pixels arranged along a second direction, which is not parallel to the first direction, and each of the light-emitting areas of the light-emitting array corresponded to the display pixels.

2. The display of claim 1, wherein every sub-pixel has a plurality of sub-areas, and the sub-areas of the sub-pixel respectively receive the lights generated from the different light-emitting areas of the corresponded light-emitting arrays.

3. The display of claim 2, wherein the dimensions of the sub-areas in the sub-pixel are substantially the same.

4. The display of claim 1, wherein the light-emitting areas of the light-emitting array emit light from a light-emitting surface;
a projection area of display pixel corresponded to the light-emitting array overlaps with the distribution area of the light-emitting array on the light-emitting surface, and the distribution area of light-emitting areas on the light-emitting surface interlaces with the distribution area of the sub-pixels projected to the light-emitting surface, wherein the area of every sub-pixel projected to the light-emitting surface overlaps with multiple distribution areas of the light-emitting areas on the light-emitting surface.

5. The display of claim 1, wherein the light-emitting areas are formed into rectangular shape and each has a first long side being perpendicular to the first direction; the sub-pixels are formed respectively into rectangular shape and each has a second long side being perpendicular to the second direction; every sub-pixel lies across and above the light-emitting areas.

6. The display of claim 1, wherein the first direction and the second direction are substantially perpendicular.

7. A display including:
a plurality of display components, each display component including:
a light-emitting array, including multiple light-emitting areas arranged along a first direction;
a display pixel, disposed on the light-emitting array;
wherein the display pixel includes a plurality of sub-pixels arranged along a second direction which is not parallel to the first direction, and every light-emitting area provides light to illuminate the sub-pixels.

8. The display of claim 7, wherein every sub-pixel has sub-areas, and the sub-areas of the sub-pixel respectively receive the lights generated from different light-emitting areas of the corresponded light-emitting array.

9. The display of claim 8, wherein the dimensions of the sub-areas in the sub-pixel are substantially the same.

10. The display of claim 7, wherein in every display component, the light-emitting areas of the light-emitting array emit light from a light-emitting surface;
a projection area of the sub-pixels on the light-emitting surface and the distribution area of the light-emitting areas on the light-emitting surface are overlapped and interlaced, wherein the area of every sub-pixel projected to the light-emitting surface overlaps with the distribution areas of all the light-emitting areas on the light-emitting surface.

11. The display of claim 7, wherein the light-emitting areas are formed into rectangular shape and each has a first long side being perpendicular to the first direction; the sub-pixels are formed respectively into rectangular shape and each has a second long side being perpendicular to the second direction; every sub-pixel lies across and above the light-emitting areas.

12. The display of claim 7, wherein the first direction and the second direction are substantially perpendicular to each other.

13. A driving method of the display of claims 1 to 12 includes:
providing a gradient data which includes a plurality of gradient values;
obtaining a maximum of the gradient values in every gradient data;
generating a light-emitting control signal according to the magnitude of the maximum;
providing the light-emitting control signal to one of the light-emitting arrays and determining the light up numbers of light-emitting area of the light-emitting array;
and providing the gradient data to sub-pixels corresponded to the light-emitting array, then adjusting the transmittance of the sub-pixels according to gradient values of the gradient data received.

14. The driving method of claim 13, wherein the step of generating the light-emitting control signal further includes:
calibrating the maximum so as to generate a calibrated maximum value;
determining the light-emitting control signal according to the calibrated maximum value.

15. The driving method of claim 13, wherein the step of generating the light-emitting control signal also includes:
determining value sections within the receiving range of gradient value of the sub-pixels, the value sections corresponded respectively to different light-emitting control signals;
wherein the light-emitting control signal is determined according to the value section of the maximum.

16. The driving method of claim 13, wherein the calibrated transmittance of sub-pixels according to the gradient value received and the magnitude of the gradient value are positively correlated.
